(19) United States
(12) Patent Application Publication
(10) Pub. No.: US 2008/0045419 A1
(43) Pub. Date: Feb. 21, 2008

(54) Screening Assay

(75) Inventor: Wolfram Siede, Benbrook, TX (US)

Correspondence Address: CHALKER FLORES, LLP, 2711 LBJ FRWY, Suite 1036, DALLAS, TX, 75234, US

(73) Assignee: University of North Texas Health Science Center at Fort Worth, Fort Worth, TX (US)

(21) Appl. No.: 11/840,855

(22) Filed: Aug. 17, 2007

Related U.S. Application Data
(60) Provisional application No. 60/838,567, filed on Aug. 18, 2006.
(60) Provisional application No. 60/868,538, filed on Dec. 4, 2006.

(51) Int. Cl. C40B 30/04; C40B 60/12

(52) U.S. Cl. 506/9; 506/39

(57) ABSTRACT

The present invention includes a system and methods for the detection, isolation and characterization of candidate agents in a functional screening assay in agarose.

### CROSS-REFERENCE TO RELATED APPLICATIONS

This application claims priority to U.S. Provisional Patent Application Ser. No. 60,868,567, filed Aug. 18, 2006, the entire contents of which are incorporated herein by reference. This application is related to U.S. Provisional Patent Application Ser. No. 60,868,538 and filed Aug. 18, 2006, the entire contents of which is also incorporated herein by reference.

### STATEMENT OF FEDERALLY FUNDED RESEARCH

This invention was made with U.S. Government support under Contract No. RO1 CA087381 awarded by the National Cancer Institute at the National Institutes of Health. The government has certain rights in this invention.

### TECHNICAL FIELD OF THE INVENTION

The present invention relates in general to the field of screening assays, and more particularly, to a high throughput screen for the identification of drug candidates in agar or agarose.

### BACKGROUND OF THE INVENTION

Without limiting the scope of the invention, its background is described in connection with screening assays.

In a cancer therapy, it is of interest to modify cellular responses to DNA damaging agents. This could mean to increase or decrease susceptibility to damage or to improve or hinder DNA repair. The goal is to increase the therapeutic window, i.e., the difference in sensitivity between normal cells and tumor cells. Of particular interest are agents that interfere with the cell cycle response to DNA damage and modify checkpoint arrest since checkpoints may already be weakened or less redundant in cancer cells.

### SUMMARY OF THE INVENTION

The present invention includes a system and method for automating the identification, isolation and characterization of compounds that modify checkpoint activating events. The present invention is a yeast based assay that screens for agents cost efficiently and fast and can also be used to purify an active compound in a mixture (e.g., plant extract). Because candidate agents are tested functionally, many possible mechanisms may be addressed by the agents at different stages of the activation process.

More particularly, the present invention includes methods, systems and devices for screening compounds that includes an array of biological samples disposed in agar or agarose, having a cell that has a first checkpoint protein linked to a DNA binding moiety and a second checkpoint protein linked to a transcriptional activation moiety; wherein the interaction of the first and second proteins is detected in the presence or absence of varying concentrations of a first agent that is contacted with the cell line and wherein the cells are exposed to one or more DNA damaging agents in situ. The cell is typically a yeast (Saccharomyces cerevisiae) cell and the first agent may also be a library of agents. The first and second proteins may be a DNA-damage induced protein interaction pair, e.g., Rad17 tested in a haploid two-hybrid reporter strain such as CG1945 co-transformed with plasmids pGBT9-Rad17 and pCAD1-Rad17.

The present invention also include a high throughput method of screening a compound library for an agent that modulates interaction of a first checkpoint protein linked to a DNA binding moiety and a second checkpoint protein linked to a transcriptional activation moiety, by exposing the cells to one or more DNA damaging agents; providing in multiple wells various concentrations of one or more individual compounds from the compound library, wherein the compound library is screened for compounds that modulate the interaction between the first and second proteins to activate one or more detectable genes under the control of the transcriptional activation moiety in cells that have been plated on agar or agarose; and detecting the change in the expression of the one or more detectable genes in situ. Detectable genes for use with the present invention may be one or more auxotrophic, fluorescence or enzymatic proteins. The modulation of the interaction between the first and second proteins may be an increase or a decrease in binding or contact between the proteins.

The present invention also includes a system for screening compounds that includes an array of biological samples disposed in agar or agarose, that includes a cell that expresses a first checkpoint protein linked to a DNA binding moiety and a second checkpoint protein linked to a transcriptional activation moiety; wherein the interaction of the first and second proteins is detected in the presence or absence of varying concentrations of a first agent that is contacted with the cell line in the agar or agarose, wherein the cells are exposed to one or more DNA damaging agents in situ; a sample-handling device that controls the time and location of the array; and a processor coupled to the sample-handling device, wherein the processor commands the sample-handling device to execute measurements specified by a program executed by the processor in order to facilitate sample handling and to detect sample information which includes at least one phenotypic characteristic. In one example, the sample analyzer may be coupled to the processor, wherein the processor captures measurements specified by the program include a measurement executed by the cell analyzer in response to a command from the processor. The sample-handling device may further include a local processor in communication with the processor, wherein the local processors controls execution of measurements specified by the processor on the cell analyzer. Alternatively, the sample-handling device may have a local processor in communication with the processor, wherein the local processors independently and selectively executes a local program or subroutine to control a sequence of measurements in response to a command from the processor.

### BRIEF DESCRIPTION OF THE DRAWINGS

For a more complete understanding of the features and advantages of the present invention, reference is now made to the detailed description of the invention along with the accompanying figures and in which:

FIG. 1 summarizes the steps for a simple assay in which a reporter strain is co-transformed with Rad17-Gal4-DNA-binding-domain and Rad17-Gal4-transcriptional-activation-domain fusions (“bait” and “prey” plasmids);

FIG. 2 shows colony growth results in a ring-shaped zone, corresponding to the effective concentration range of the tested DNA-damaging agent;

FIG. 3 shows the activity of various CPT derivatives in the DNA-damage-induced increased protein interaction (DIPI) assay colony growth assay;

FIG. 4 shows the steps and results in the adaptation of the DIPI assay to 96 well microtiter dish format;

FIG. 5 shows the steps in the assay of screening for CPT-modifying agents;

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The continued need to find small molecules that are active in cancer therapy and to characterize novel agents that amplify their effect. The present invention includes automating a new and unique yeast tool to address a sophisticated screening goal benefiting cancer treatment that would be difficult to address with existing technology.

Agents that have been successfully applied in cancer chemotherapy frequently introduce DNA damage and, as a consequence, trigger cell cycle arrest or apoptosis. The responsible cellular regulatory networks are frequently referred to as the checkpoint system. A two-hybrid-system based assay was developed that detects increased interaction between certain checkpoint proteins following certain DNA-damaging treatments (DNA-damage-induced increased protein interaction (DIPI)). This phenomenon accompanies checkpoint activation and can be detected by colony growth on selective medium in specially constructed strains of the yeast Saccharomyces cerevisiae. Thus, the simple assay is unique and extremely relevant since it detects an activity that is most likely directly related to cancer control. The suitability of this assay for high-throughput screening is described herein. The assay is especially responsive to topoisomerase I inhibitors such as the established chemotherapy drug camptothecin (CPT). Novel compounds may be further isolated that enhance or diminish the checkpoint-activating effect of CPT. It is expected that the usefulness of this agent family of inhibitors can be enhanced by providing adjuvants that enhance its effect on tumor cells or blunt its toxicity towards normal cells.

Development of the DIPI assay into a high-throughput screening tool, with special emphasis on screening for agents that modify the CPT effect. A yeast reporter strain transformed with plasmids containing the Rad17 checkpoint protein fused to the Gal4 activation domain and Rad17 fused to the Gal4 DNA binding domain shows increased growth on histidine-free medium due to increased homomeric interaction in the presence of CPT. It was shown that this assay can be performed in 96 well plates and the conditions may be modified so that the detected colony growth response allows for library screening of agents that enhance or weaken the response.

Modification and test the instrumentation for high throughput screening (HTS). An existing 96 well plate HTS instrument will be modified to implement the DIPI assay. Various automation steps will include dispensing of agar, inoculation with cells, application of compound library and determination of colony number through image analysis.

Screening of a compound library for agents that modify the effects of camptothecin. After having successfully adapted the DIPI assay for high-throughput screening and having built the necessary instruments, a compound library will be screened for agents that modify the checkpoint-activating effect of CPT. The National Cancer Institute's Diversity Compound may be screened and include a diverse set of 1,900 agents. The result of the high-throughput system can be easily compared to previously performed manual screens with the same library (that did not employ optimized conditions). Possible hits will be verified in secondary screens and further characterized since a variety of mechanisms can be invoked to cause an intensified effect of CPT or to result in protection. Many of these activities may also be of interest in other contexts.

In the end, the system and methods of the present invention were developed and validated to establish a robust, cost efficient and rapid screening system for agents which activate checkpoints or modify the efficiency of known checkpoint-activating agents. Using the present invention, lead compounds that can be developed into amplifiers or adjuvants in camptothecin cancer chemotherapy. Such lead compounds may already be identified during the planned initial library screen or later, during a large scale-library screen of a combinatorial library of, e.g., compounds designed based on the base-compound identified in the first screen.

Chemotherapy of cancer relies on differential sensitivity between normal cells and tumor cells (therapeutic index). There is a lot of interest in developing novel compounds that are active but also in non-toxic compounds that work as amplifiers, by increasing the effect of an established drug. A versatile two-hybrid system based yeast screening tool was developed that allows screening for such compounds by measuring checkpoint activation as colony growth.

Checkpoints, DNA Damage and Cancer Therapy. Eukaryotic cells are able to reversibly arrest cell cycle progression in response to DNA damage. The activated signal-transduction pathways are part of a multi-faceted response network and are also involved in optimizing DNA repair, e.g. through transcriptional regulation. These so-called checkpoint responses are largely conserved among eukaryotic organisms and the yeast Saccharomyces cerevisiae serves as an invaluable model system (8, 13). By providing time for DNA repair and enhancing DNA repair or damage tolerance, checkpoints are essential for maintaining genetic stability. Genetic instability is a hallmark of cancer cells and it is not surprising that checkpoint pathways are commonly compromised in cancer cells. Responses to checkpoint activation differentiate between normal cells and cancer cells and provide therapeutic opportunities (11). Indeed, radiation therapy and many established chemotherapy agents introduce DNA damage and trigger certain checkpoint and interconnected apoptosis pathways. Several groups of agents (typically small molecules) hold promise for cancer therapy: (1) agents that activate checkpoint pathways by introducing damage; (2) agents that activate checkpoint pathways without introducing damage directly; and/or (3) agents that modify checkpoint responses. The latter type of agent can be used to amplify a differential checkpoint response in challenged tumor cells vs. normal cells. For instance, a pathway that is intact in both can be inhibited and increase the sensitivity of cancer cells specifically since no functionally redundant pathways may be intact.

Because of its genetic versatility, the yeast Saccharomyces cerevisiae has recently attracted considerable interest as a eukaryotic model organism for drug screening in general and for anti-cancer drug screening in particular. A two-hybrid system-based yeast assay was developed that is adapted to characterize or screen for the types of checkpoint-activating or -modifying agents discussed above. The initial step of DNA damage recognition during the course of checkpoint activation involves crosstalk between several sensor proteins. In the yeast Saccharomyces cerevisiae, one of these is Rad17 (named Rad1 in Schizosaccharomyces pombe and Homo sapiens)—it participates together with Mec3 and Ddc1 in formation of a PCNA-like sliding clamp complex. It was found that certain DNA-damaging agents induce an increased self-interaction of Rad17. By genetic strategies related to the two-hybrid system, this increased interaction can be converted into a growth response. Although the mechanism is not yet entirely clear, analysis of Rad17 point mutations indicates an important role of Rad17 homomeric interaction for checkpoint activation, possibly through some kind of signal amplification by higher-order complex formation.

Thus, this assay is unique since it does not detect an indirect consequence of DNA damage (such as growth inhibition) but it measures an activity that is most likely directly related to anti-cancer drug activity—the capability to trigger the checkpoint system. This assay proved to be especially sensitive to topoisomerase I inhibitors of the camptothecin type.

Camptothecin in Cancer Therapy. As a result of a natural compound screen by the National Cancer Institute, the parent compound camptothecin was identified over 40 years ago in the oriental tree Camptotheca acuminate. Camptothecin (CPT) was characterized as a topoisomerase I inhibitor. Type I topoisomerases are required for relaxing DNA supercoiling through transient introduction of single-stranded breaks, a necessary step during DNA transactions such as replication or transcription. Being a replication-associated target, cancer cells are likely to be especially sensitive to the inhibition of topoisomerase. CPT binds directly to the topoisomerase protein, stabilizing the protein-DNA complex (“cleavable complex”) and preventing the re-ligation step. An approaching replication fork may convert such a stable DNA single strand break into a double-strand break. These types of DNA damage are highly efficient in triggering cell cycle checkpoints.

CPT derivatives such as topotecan and irinotecan are being successfully used against a variety of cancers, especially colon, ovarian and lung cancer (1). However, significant limitations clearly exist. This pertains primarily to the toxicity of the compounds (hematopoietic and gastrointestinal). Namely, the major side effects are neutropaenia and diarrhea, which occur over an incidence range of 20-40%, but also sepsis (5-10%). Furthermore, drug removal results in loss of activity within minutes since the trapped complex is released, necessitating long and repeated infusions during cancer treatment. Tumor resistance has also been frequently observed and agents that inhibit topoisomerase activity through other mechanisms are currently being under investigation.

Agents that amplify the therapeutic effect of a primary anti-cancer drug, preferably without any toxic effects by themselves, are actively being investigated for many agents (including radiation) and also specifically for camptothecins. For example, platinum DNA adducts were shown to enhance the camptothecin effect on topoisomerase I inhibition.

The DIPI assay is adapted for high throughput screening and begin to identify compounds that modify (amplify or reduce) the checkpoint-activating effect of camptothecin. Positive result in the yeast assay then undergo several secondary screens before a verification in higher eukaryotic cells should be attempted.

Characterization of the isolated agents. This may include testing in DNA repair mutants that are defective in specific DNA repair pathways. Using the high-throughput system of the present invention, a larger scale library may be screened to increase the number of lead compounds.

The combination therapy of irinotecan and fluoropyrimidines is the first-line therapy for metastatic colon cancer. Colon cancer overall is the third most frequently diagnosed type of cancer, with 900,000 new cases and 500,000 deaths annually. The global therapeutic market for colon cancer currently amounts to $4.8 billion.

DNA-damage-induced self-interaction of Rad17 can easily be visualized in the yeast two-hybrid system. A reporter strain is co-transformed with Rad17-Gal4-DNA-binding-domain and Rad17-Gal4-transcriptional-activation-domain fusions (“bait” and “prey” plasmids). Enhanced protein-protein interaction is visualized by activation of a Gal4responsive chromosomal reporter gene construct required for histidine synthesis (HIS3) (FIG. 1).

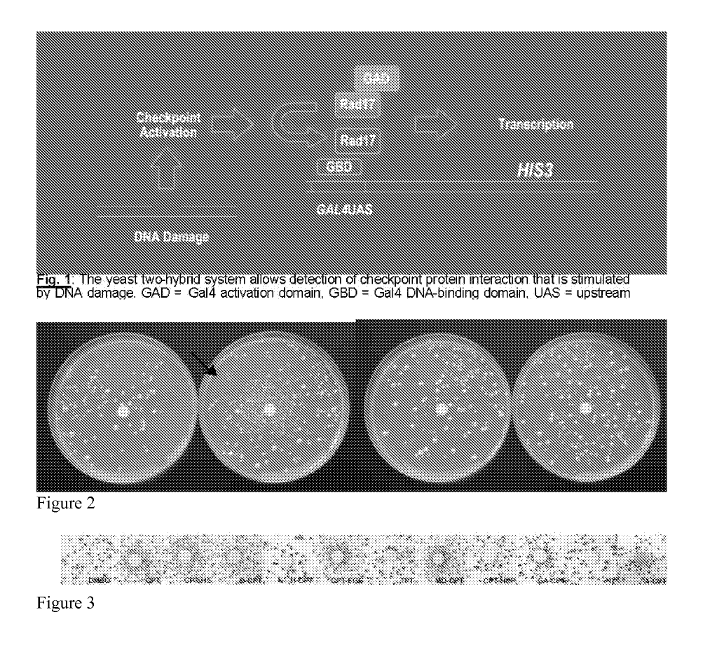

These cells are exposed to a DNA-damaging agent in form of a gradient on a histidine-omission plate. Consequently, colony growth results in a ring-shaped zone, corresponding to the effective concentration range of the tested DNA-damaging agent (FIG. 2). It should be noted that there is background colony growth which is not centered around the filter paper (possibly indicative of a low level of constitutive interaction). It should also be mentioned that the use of a blue color marker (LacZ gene) is possible. It is not unusual that the context of a promoter affects the specific interaction and may be easily addressed by switching to one of a wide variety or readily available commercial and non-commercial expression systems.

The DIPI assay (for DNA-damage induced protein interaction). The assay was found to be very responsive to certain DNA damaging agents such as 4-nitroquinoline-N-oxide and especially to camptothecin. Many other agents that damage DNA and trigger checkpoints do not elicit a similar response. One reason may be the dependency of the assay read-out on colony growth, i.e. an agent that causes a high degree of lethality in the checkpoint-triggering range of concentrations may not show the expected response.

FIG. 1 shows that the yeast two-hybrid system allows detection of checkpoint protein interaction that is stimulated by DNA damage. GAD=Gal4 activation domain, GBD=Gal4 DNA-binding domain, UAS=upstream activating sequence. Typical checkpoint activating damage includes double-strand breaks or single-stranded DNA tracts.

Using the DIPI assay to reliably predict biological activity and checkpoint activation of genotoxic compounds. The screening assay of the present invention was used to test a class of substances. A series of derivatives of the topoisomerase I inhibitor and anti-cancer CPT have been characterized. As a unique advantage over cells from other species, yeast cells are still viable after a complete inactivation of topoisomerase I (by TOP1 gene deletion). First, the assay read-out was validated by showing the absence of increased homomeric Rad17 interaction in a top1δ background (FIG. 2). In other words, the response does indeed depend on the presence of the relevant CPT target (topoisomerase I). Next, various CPT derivatives were classified in the DIPI assay as inducing Rad17 self-interaction or not (FIG. 3).

Next, the DIPI assay results were compared with the capability of these drugs to activate checkpoints by detecting cell cycle arrest in late S/G2 in response to treatment (FACS analysis) and by hyperphosphorylation of Rad53 kinase, indicative of checkpoint pathway activation. General genotoxic activity by measuring inactivation of macrocolony formation was also determined. It was found that the DIPI assay correctly predicts the ability of CPT analogs to activate the checkpoint pathways and to cause cell cycle arrest in yeast. Additionally, the ability to activate checkpoint pathways was clearly correlated with lethality. (Because of the low CPT lethality in yeast, a repair-deficient and thus sensitized genetic background had to be used.)

FIG. 2 shows the positive CPT response in the DIPI assay (arrow) depends on the presence of the cellular target topoisomerase I. The cells are WT [pCAD1-Rad17/pGBT9-Rad17] [pCAD1-Rad17/pGBT9-Rad17], respectively. Enhanced Rad17 self-interaction is measured in the two-hybrid-based gradient assay. Responses in a wild-type reporter strain (WT, left two plates) and a mutant deleted for topoisomerase I (top1δ, right) are compared. Cells of the reporter strain (CG1945), previously co-transformed with Rad17 bait/prey Gal4-fusions (pCAD1-Rad17/pGBT9-Rad17) were plated as indicated. The genotoxic agent CPT or DMSO (solvent control) was applied on a filter paper. Colony growth on -His medium around the filter paper (arrow) indicates reporter gene activation in the wild type and thus Rad17/Rad17 interaction.

DIPI assay was used to identify novel DNA-damage checkpoint triggering agents among uncharacterized compounds. The suitability of the DIPI assay for high-throughput screening (unpublished data) was investigated. A set of 1,990 compounds had been provided by the Developmental Therapeutics Division of the National Cancer Institute (“diversity set”) in a 96 well plate format. Using manual replicating on large petri dishes, these were transferred to -His plates that had been inoculated with cells of a reporter strain, co-transformed with Rad17 bait/prey plasmids as described. Plates were scored by eye for a growth pattern around compound spots similar to FIG. 2 or 3. Without knowing the identity of the agents, 36 compounds were selected as potentially giving a positive response and two were confirmed later in a re-screen as increasing Rad17 self-interaction. These were identified as camptothecin and glycine 4-ethyl-3,4,12,14-tetrahydro-3,14-dioxo-1H-pyrano[3′, 4′:6,7]indolizino[1,2-b]quinolin-4-yl ester, (S)-monohydrochloride (NSC606985), a camptothecin analog. Thus, this limited screening study suggests a high selectivity of the assay for the effect of topoisomerase I inhibitors—agents that are of significant interest in cancer therapy.

DIPI assay was performed in a high-throughput mode. The Petri dish assay was adapted to the 96 well plate format in order to use conventional high-throughput machinery. Two protocols were explored (FIG. 4). In both cases, the selective agar medium lacking leucine, tryptophan and histidine was poured in the plate wells. In protocol 1, cell suspension was pipeted on top of the plate and, after drying, a sample of CPT. In protocol 2, cells were mixed with agar and pipeted, resulting in a cell-containing agar layer. CPT was added on top. After 3-4 days, the plates were evaluated for colony growth. Clearly, as can be seen, the number of colonies increased significantly in the treated sample as compared to the control. This can be determined even without magnification and very clearly microscopically, under low magnification (FIG. 4). The few colonies of the background appear to be faster growing than the induced ones. Nevertheless, fairly basic image analysis should allow identification of a positive response.

FIG. 4 shows the adaptation of the DIPI assay to 96 well microtiter dish format. Top: two protocols were used to seed cells and apply CPT, resulting in colonies on the surface and those embedded in agar. Bottom left: number of colonies is increased by CPT but not by the solvent DMSO (protocol 1 results shown only). Bottom: same, but picture taken without microscope. This particular yeast strain forms red-pigmented colonies.

DIPI high-throughput assay screening tool, with special emphasis on screening for agents that modify the camptothecin effect. The DIPI assay correctly predicts CPT-like activities. As shown herein, the possible adaptability of the assay for high-throughput robotic screening. Several applications of this assay are feasible. For example, a library of CPT derivatives may be screened. Novel topoisomerase inhibitors may be identified in a large library screen and this assay would be suitable for this purpose. The versatility of the assay allows for advanced screening that can not be accomplish using existing technology.

Screen for agents that amplify or reduce the CPT effect. The same screen will simultaneously allow the identification of agents that increase and reduce the checkpoint-activating effect of CPT. The latter may be of interest in blunting toxic effects of the treatment or may find applications in very different contexts (i.e. radiation protection).

As discussed above, there is considerable clinical interest in adjuvant therapy with CPT. Combination therapy of CPT and platinum compounds or fluoropyrimidines is already being applied. Using a non-toxic amplifier of the topoisomerase I inhibitory effect may ameliorate problems of toxicity, resistance and the short effective half-life. The therapeutic window (i.e. the differential sensitivity between normal cells and tumor cells) may also be increased. Several mechanisms can be assumed and the screen does not exclude any of these, e.g. DNA binding, influence on replication, influence on redundant checkpoint pathways and several others.

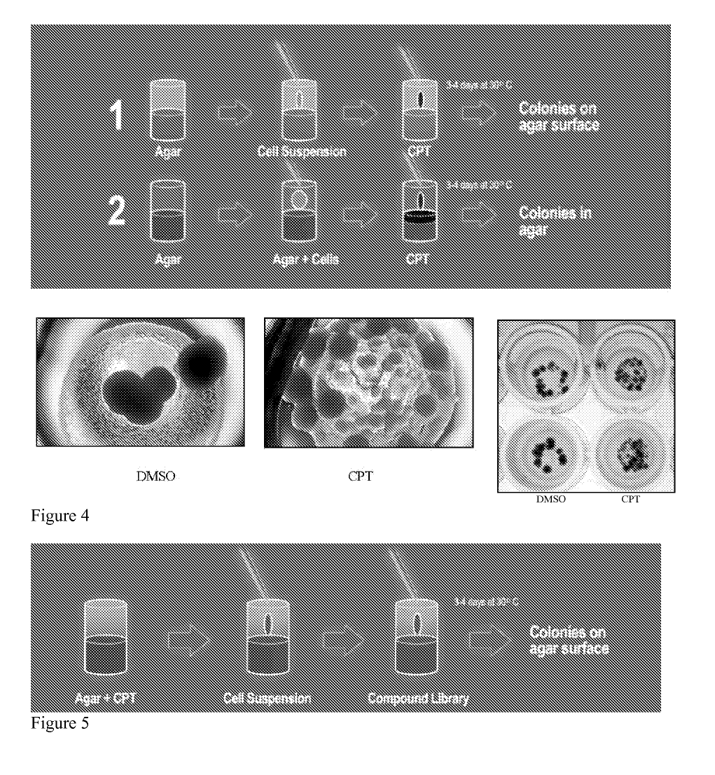

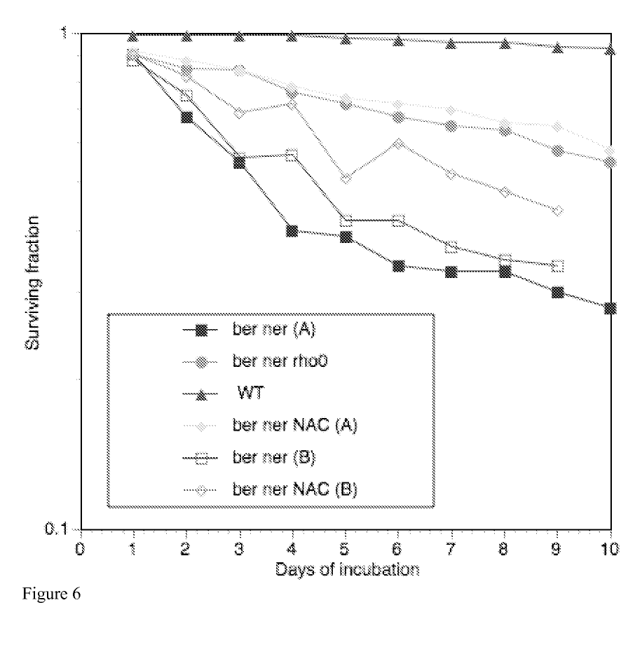

All cells will be exposed to a CPT concentration that leads to some low amount of colony formation on selective medium. Briefly, the haploid two-hybrid reporter strain CG1945 (4) is co-transformed with plasmids pGBT9Rad17 and pCAD1-Rad17. Since there is some variability in the response of different clones, several transformants will be pre-tested for a positive CPT response and the best responder will be selected for further studies (preserving these co-transformants as frozen cells may be possible). The selected co-transformant is grown up to stationary phase in yeast synthetic medium (SM) without tryptophan and leucine to retain both plasmids. Incubation period is typically two days at 30° C. with shaking. The standard recipe for yeast SM calls for 2% dextrose, 0.67% yeast nitrogen base with ammonium sulfate/without amino acids (e.g. from US Biological) and a -Trp-Leu amino acid dropout mix (Qbiogene, Inc.). For a screen of agents that modify CPT action, a culture of cells that is homogenously exposed to CPT and add the compound library to it may be used (FIG. 5). FIG. 5 shows the steps in the assay of screening for CPT-modifying agents.

Agar medium containing 1.4% agar, 2% dextrose, 0.67% yeast nitrogen base, a tryptophane, leucine and histidine-free amino acid mix (610 mg/l, Qbiogene, Inc.) and 1.25 mM aminotriazole is mixed with CPT (SIGMA). Aminotriazole is typically included to reduce the spontaneous background growth due to expression of the HIS3 reporter gene. The exact amount will have to be determined. A study range of 5-20 μg/ml, dissolved in DMSO, was used. 200 μl (or less, to be determined) of this mix is poured into each well of a 96 well plate. The compound library may now be added directly on top of the dried cell suspension. The following parameters may also be optimized: (1) Cell number used; (2) CPT concentration; and/or (3) Aminotriazole concentration.

Simple optimization may include minimizing the number of background colonies as low as possible and maintaining a damage-induced level of colonies that makes a screening for agents that reduce or increase this number feasible. The availability of a true CPT-action modifying agent would be important in validating successful development of the assay. Manual screening of the NCI's diversity set resulted in the isolation of a compound (NSC109268) that reduces the CPT effect. This compound was employed to prove that appropriate conditions have been established.

A highly toxic agent will obviously kill the majority of cells, however, the formed concentration gradient may still allow its identification as a CPT-action modifying agent. As an alternative, cells may be embedded in an additional agar layer or even in the agar base. This, however, makes the plate pouring step somewhat more cumbersome since yeast cells cannot be exposed for too long to temperatures that prevent agar from solidifying.

Modify and test the instrumentation for high throughput screening (HTS). An existing 96 well plate HTS instrument is modified to implement the DIPI assay. Various automation steps will include dispensing of agar, inoculation with cells, inoculation with one or more members or pools of a compound library and determination of colony number through image analysis.

Isolation of novel agents that increase or decrease the checkpoint-activating potential of CPT from the NCI diversity set library. The screening protocol will be established as described with modifications based on each study design, as will be know to the skilled artisan in light of the present disclosure. Briefly, cells of the reporter strain will be transformed with both Rad17 plasmids and seeded on or in CPT-containing selective agar medium in 96 well microtiter plates as described. The compound library will be applied. Following growth at 30° C., the number of colonies—reflecting the strength of protein interaction and thus checkpoint activation—will be determined using image analysis software.

The skilled artisan may select the appropriate CPT concentration and cell titer that allow a certain increase of colony number above background. The goal is not to saturate the assay but still provide higher initial level of colony growth in order to allow for screening of agents that increase or decrease this level. The main purpose is the selection of agents that increase (or decrease) the most relevant consequence of topoisomerase inhibition by CPT activity—checkpoint activation. Especially, if the agents by themselves are non-toxic, important therapeutic tools may be provided. Agents that cause the opposite effect may also be of interest in certain context if toxic effects can be diminished. Follow-up studies with animal models will be necessary to further characterize the usefulness of these lead compounds.

For example, freely available compound library may be used for initial candidate screening, e.g., NCI's Developmental Therapeutics Branch. This library of 1,900 substances, termed diversity set, is specifically designed for evaluation of screening systems and contains representative examples of a variety of different classes of agents. Screened this library can be done in manual or automated mode (replicating onto petri dishes and visual inspection of growth patterns). A simple screen for checkpoint-activating agents yielded CPT itself and a closely-related compound. Using the present invention, the assay was used to isolate one substance (NSC109268) that appeared to reduce checkpoint activation by CPT as measured by the DIPI assay. Further characterization confirmed that NSC109268 can indeed reduce the lethal and growth-inhibitory effect of CPT and of other DNA-damaging agents.

Re-isolation of NSC109268 in the automated version may be used to validate the system set-up. However, it should also be noted that the previous manual screen had preliminary character since conditions had not been optimized. The conditions were certainly not designed for specifically picking up substances that amplify the CPT effect. Therefore, it would not be too surprising to find additional compounds and this would further verify the versatility and accuracy of the system.

Secondary Tests. Candidate compounds may be retested individually on gradient plates, in the conventional DIPI setup. Secondary screens using different reporter genes or host strains will also be useful for system-independent verification. LacZ may be used as a marker. Other readily available markers or detectable agents may be used. Upon identification, the isolated compound will undergo secondary screens to distinguish real modifiers of CPT action from unspecific effects. The following may be tested: (1) Is the compound specific for Rad17-Rad17 interaction or does it introduce some unspecific growth response? For example, since growth on histidine-free medium serves as the readout, a compound affecting histidine metabolism (without actually stimulating two-hybrid interaction) may have been isolated. This is simply resolved by using a strain transformed with one of the two-hybrid plasmids without insert. In such a vector control assay (which will be performed on plates) the compound should have no effect, with or without CPT. (2) Is the effect of the compound dependent on the presence of CPT? In the simplest case, another CPT derivative may be isolated whose effect is simply additive with CPT. Effects on topoisomerase I can easily be distinguished by using the (viable) top1δ mutant which was constructed in a two-hybrid reporter strain (see e.g., FIG. 2).

After these secondary screens, compounds that may be true modifiers of CPT action may have been isolated. A quantitative measurement of the effect of the candidate drug (X) on CPT action can also be determined. Briefly, logarithmic-phase haploid yeast cells are incubated with CPT, with candidate agent(s) X, with a combination of CPT and X. The present assay can measure: (1) lethality, using a standard colony-forming assay (because of the low lethality of CPT in normal yeast, a repair-deficient mutant may have to be used); and (2) checkpoint activation (checkpoint activation can be measured using flow-cytometry as cell cycle arrest). Checkpoint activation can also be monitored by the phosphorylation status of the Rad53 kinase which can be visualized by SDS-PAGE gel electrophoresis.

A two-hybrid assay-based yeast system was used to screen small-molecule compound libraries for agents that modify cell cycle checkpoint activation. Checkpoint activation is measured as the DNA-damaged-induced increased interaction between two selected checkpoint proteins. From a 1,900 small-molecule library provided by the Developmental Therapeutics Branch of the National Cancer Institute, compound NSC109268 was found to interfere with checkpoint activation in response to the topoisomerase I inhibitor camptothecin. Closer inspection of NSC109268's activity suggests that its mode of action does most likely not reflect a specific effect on checkpoint signaling; rather, it appears to protect yeast cells from the lethal effect of certain DNA damaging agents.

As another example, the drug streptonigrin was used as a double-strand break inducing drug. After treatment of logarithmically growing yeast cultures for 1 h at 30° C. in YPD medium (1% yeast extract, 2% peptone, 2% dextrose), lethality was measured by inability of colony formation on YPD agar plates (Amberg, D. C., D. J. Burke, and J. N. Strathern. 2005. Methods in Yeast Genetics: A Cold Spring Harbor Laboratory Course Manual, 2005 Edition. Cold Spring Harbor Laboratory Press, Cold Spring Harbor, N.Y.). A protective effect of NSC109268 was evident and most visible in a rad51 mutant, defective in double-strand break repair by homologous recombination. The compound itself exhibited moderate toxicity. The used concentration of 50-100 μg/ml results in 80% survival after 1 h incubation. Similar protective effects were found with an alkylating agent (MNNG) and, less significantly, also with ionizing radiation (¹³⁷Cs γ-radiation). The compound does not seem to affect sensitivity to another alkylating agent (MMS), to ultraviolet radiation (UV-C) or to phleomycin (see Table 1).

Curiously, the opposite effect was found for other agents such hydrogen peroxide (H₂O₂), an oxidative agent causing base damage and strand breaks. Here, sensitivity is enhanced by simultaneous exposure to NSC109268. A similar observation was made with the anticancer drug cisplatin (cis-Diammineplatinum (II) dichloride, Sigma-Aldrich Corp., Cat. No. P4394).

NSC109268 may protect from or facilitate the initial introduction of damage, may inhibit or facilitate DNA repair or may increase or reduce lethal consequences of DNA damage. An influence on cell cycle progression that may be critical for these effects was also observed. Furthermore, the chemistry of NSC109268 suggests possible intercalation into DNA. The Cu²⁺ ions that are bound may influence radical emergence close to DNA and modify the efficiency of agents that rely on radical production.

In summary, the incubation of logarithmic phase wild-type and double-strand break repair deficient (rad51) yeast cells with compound NSC109268 had the following effects on sensitivity towards DNA damaging agents, measured as survival of macrocolony forming cells (+increased resistance, −decreased resistance, ND not determined):

TABLE 1
Summarized the effects of the DNA Damaging Agents
on repair-proficient wild type and rad 51⁻ cells

| DNA damaging agent | strain WT | strain rad51 |
|---|---|---|
| Streptonigrin | + | +++ |
| MNNG | + | +++ |
| MMS | ND | +/− |
| Phleomycin | +/− | + |
| Camptothecin | (+) | ++ |
| Ionizing radiation (¹³⁷Cs) | (+) | + |
| Ultraviolet light | +/− | +/− |
| H₂O₂ | ND | −− |
| Cisplatin | − | − |

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Adams, V., and T. Burke (ed.). 2005. Camptothecins in Cancer Therapy. Humana Press, Totowa, N.J.
2. Barberis, A., T. Gunde, C. Berset, S. Audetat, and U. Lüthi. 2005. Yeast as a screening tool. Drug Discov. Today 2:187-192.
3. Dunstan, H. M., C. Ludlow, S. Goehle, M. Cronk, P. Szankasi, D. R. H. Evans, J. A. Simon, and J. R. Lamb. 2002. Cell-based assays for identification of novel double-strand break-inducing agents. J. Natl. Cancer Inst. 94:88-94.
4. Feilotter, H. E., G. J. Hannon, C. J. Ruddel, and D. Beach. 1994. Construction of an improved host strain for two hybrid screening. Nucleic Acids Res. 22:1502-1503.
5. Fiorani, P., and M.-A. Bjornsti. 2000. Mechanisms of DNA topoisomerase I-induced cell killing in the yeast Saccharomyces cerevisiae. Annals New York Acad. Sciences:65-75.
6. Flatten, K., N. T. Dai, B. T. Vroman, D. Loegering, C. Erlichman, L. M. Kamitz, and S. H. Kaufmann. 2005. The role of checkpoint kinase I in sensitivity to topoisomerase I poisons. J. Biol. Chem. 280:14349-14355.
7. Friedberg, E. C., G. C. Walker, and W. Siede. 1995. DNA Repair and Mutagenesis. American Society of Microbiology Press, Washington, D.C.
8. Friedberg, E. C., G. C. Walker, W. Siede, R. D. Wood, R. A. Schultz, and T. Ellenberger. 2005. DNA Repair and Mutagenesis, 2nd Edition. American Society of Microbiology Press, Washington, D.C.
9. Garcia-Carbonero, R., and J. G. Supko. 2002. Current perspectives on the clinical experience, pharmacology, and continued development of the camptothecins. Clin. Cancer Res. 8:641-661.
10. Kawanishi, S., and Y. Hiraku. 2004. Amplification of anticancer drug-induced DNA damage and apoptosis by DNA-binding compounds. Curr. Med. Chem.-Anti-Cancer Agents 4:415-419.
11. Kohn, K. W., J. Jackman, and P. M. O'Connor. 1994. Cell cycle control and cancer chemotherapy. J. Cell. Biochem. 54:440-452.
12. Mager, W. H., and J. Winderickx. 2005. Yeast as a model for medical and medicinal research. Tr. Pharmacol. Sci. 26:265-273.
13. Nyberg, K. A., R. J. Michelson, C. W. Putnam, and T. A. Weinert. 2002. Toward maintaining the genome: DNA damage and replication checkpoints. Annu. Rev. Genet. 36:617-656.
14. Pommier, Y., C. Redon, V. A. Rao, J. A. Seiler, O. Sordet, H. Takemura, S. Antony, L. Meng, Z. Liao, G. Kohlhagen, H. Zhang, and K. W. Kohn. 2003. Repair of and checkpoint response to topoisomerase I-mediated DNA damage. Mutat. Res. 532:173-203.
15. Prudhomme, M. 2004. Combining DNA damaging agents and checkpoint I inhibitors. Curr. Med. Chem.-Anti-Cancer Agents 4:435-438.
16. Seiter, K. 2005. Toxicity of the topoisomerase I inhibitors. Expert Opin. Drug Saf. 4:45-53.
17. Sharma, V., T. A. Lansdell, S. Peddibhotla, and J. J. Tepe. 2004. Sensitization of tumor cells toward chemotherapy: enhancing the efficacy of camptothecin with imidazolines. Chem. Biol. 11:1689-1699.
18. Simon, J. A., and A. Bedalov. 2004. Yeast as a model system for anticancer drug discovery. Nat. Rev. Cancer 4:481-492.
19. Simon, J. A., P. Szankasi, D. K. Nguyen, C. Ludlow, H. M. Dunstan, C. J. Roberts, E. L. Jensen, L. H. Hartwell, and S. H. Friend. 2000. Differential toxicities of anticancer agents among DNA repair and checkpoint mutants of Saccharomyces cerevisiae. Cancer Res. 60:328-333.
20. Toussaint, M., G. Levasseur, J. Gervais-Bird, R. J. Wellinger, S. A. Elela, and A. Conconi. 2006. A high-throughput method to measure the sensitivity of yeast cells to genotoxic agents in liquid cultures. Mutat. Res. 606:92-105.
21. van Waardenburg, R. C., L. A. de Jong, M. A. van Eijndhoven, C. Verseyden, D. Pluim, L. E. Jansen, M.-A. Bjornsti, and J. H. Schellens. 2004. Platinated DNA adducts enhance poisoning of DNA topoisomerase I by camptothecin. J. Biol. Chem. 279:54502-54509.
22. Zhang, H., and W. Siede. 2003. Validation of a novel assay for checkpoint responses: characterization of camptothecin derivatives in Saccharomyces cerevisiae. Mutat. Res. 527:37-48.
23. Zhang, H., Z. Zhu, G. Vidanes, D. Mbangkollo, Y. Liu, and W. Siede. 2001. Characterization of DNA damage-stimulated self-interaction of Saccharomyces cerevisiae checkpoint protein Rad17p. J. Biol. Chem. 276:26715-26723.

What is claimed is:

1. An apparatus for screening compounds comprising:
an array of biological samples disposed in agarose, comprising:
a cell comprising a first checkpoint protein linked to a DNA binding moiety and a second checkpoint protein linked to a transcriptional activation moiety; wherein the interaction of the first and second proteins is detected in the presence or absence of varying concentrations of a first agent that is contacted with the cell line and wherein the cells are exposed to one or more DNA damaging agents in situ.

2. The apparatus of claim 1, wherein the cell is a yeast cell.

3. The apparatus of claim 1, wherein the first agent comprises a library of agents.

4. The apparatus of claim 1, wherein the first and second proteins comprise a DNA-damage induced protein interaction pair.

5. The apparatus of claim 1, wherein the first and second proteins comprises Rad17.

6. The apparatus of claim 1, wherein the cell comprises a haploid two-hybrid reporter strain CG1945 co-transformed with plasmids pGBT9-Rad17 and pCAD1-Rad17.

7. A high throughput method of screening a compound library for an agent that modulates interaction of a first checkpoint protein linked to a DNA binding moiety and a second checkpoint protein linked to a transcriptional activation moiety, comprising:
exposing the cells to one or more DNA damaging agents;
providing in multiple wells various concentrations of one or more individual compounds from the compound library, wherein the compound library is screened for compounds that modulate the interaction between the first and second proteins to activate one or more detectable genes under the control of the transcriptional activation moiety in cells that have been plated on agarose; and
detecting the change in the expression of the one or more detectable genes in situ.

8. The method of claim 7, wherein the detectable genes express one or more auxotrophic, fluorescence or enzymatic proteins.

9. The method of claim 7, wherein the modulation of the interaction between the first and second proteins is an increase in binding.

10. The method of claim 7, wherein the modulation of the interaction between the first and second proteins is a decrease in binding.

11. A system for screening compounds comprising:
an array of biological samples disposed in agarose, comprising:
a cell comprising a first checkpoint protein linked to a DNA binding moiety and a second checkpoint protein linked to a transcriptional activation moiety; wherein the interaction of the first and second proteins is detected in the presence or absence of varying concentrations of a first agent that is contacted with the cell line in the agarose, wherein the cells are exposed to one or more DNA damaging agents in situ;
a sample-handling device that controls the time and location of the array; and
a processor coupled to the sample-handling device, wherein the processor commands the sample-handling device to execute measurements specified by a program executed by the processor in order to facilitate sample handling and to detect sample information which includes at least one phenotypic characteristic.

12. The system of claim 11, further comprising a sample analyzer coupled to the processor, and wherein measurements specified by the program include a measurement executed by the cell analyzer in response to a command from the processor.

13. The system of claim 11, wherein the sample-handling device has a local processor in communication with the processor, wherein the local processors controls execution of measurements specified by the processor on the cell analyzer.

14. The system of claim 11, the sample-handling device has a local processor in communication with the processor, wherein the local processors independently and selectively executes a local program or subroutine to control a sequence of measurements in response to a command from the processor.

15. The system of claim 11, wherein the cell is a yeast cell.

16. The system of claim 11, wherein the first agent comprises a library of agents.

17. The system of claim 11, wherein the first and second proteins comprise a DNA-damage induced protein interaction pair.

18. The system of claim 11, wherein the first and second proteins comprises Rad17.

19. The system of claim 11, wherein the cell comprises a haploid two-hybrid reporter strain CG1945 co-transformed with plasmids pGBT9-Rad17 and pCAD1-Rad17.
